(19) United States
(12) Patent Application Publication
(10) Pub. No.: US 2009/0058147 A1
(43) Pub. Date: Mar. 5, 2009

(54) ROOF MODULE FOR A VEHICLE AND INSTALLATION METHOD THEREFOR

(76) Inventors: Norbert Elbs, Munich (DE); Matthias Dichtl, Eurasburg (DE)

Correspondence Address: DICKINSON WRIGHT PLLC, 1875 Eye Street, NW, Suite 1200, WASHINGTON, DC, 20006, US

(21) Appl. No.: 11/913,221

(22) PCT Filed: May 29, 2006
(86) PCT No.: PCT/DE2006/000921

§ 371 Date: Jun. 24, 2008

(30) Foreign Application Priority Data
May 30, 2005 (DE) 102005024659.1

(51) Int. Cl. B62D 25/06; B29C 65/48

(52) U.S. Cl. 296/210; 156/60

(57) ABSTRACT

The invention relates to a roof module for a vehicle with an outer skin (12), on the inside of which a support structure (14) containing plastic material is integrally formed, the support structure being provided on its inside with an adhesive surface (18) which is designed for resting on the edge (22) of an opening in the bodywork in order to be adhesively bonded to the vehicle bodywork. According to the invention, the support structure (14) is provided with an undercut (24) between the adhesive surface (18) and the outer skin (12). The invention furthermore relates to a corresponding method of production.

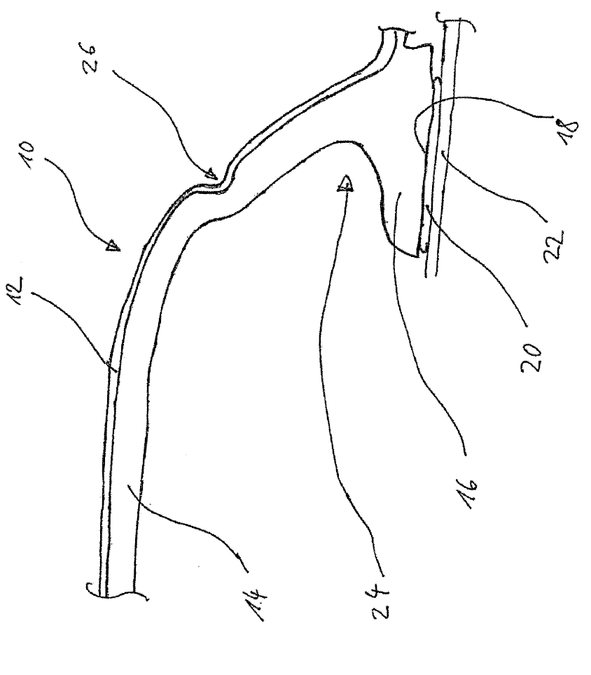

The invention relates to a roof module for a vehicle according to the generic part of claim 1, a vehicle provided with such roof module as well as a method for installation of such roof module on the vehicle.

A generic roof module is described in DE 199 47 238 A1, for example, whereby the outer skin is back-foamed or back-pressed with the support structure.

Because of the predetermined layout of the adhesive track in the vehicle body—and thus the adhesive surface of the support structure of the roof module—the support structure has to exhibit relatively large variations in thickness under the circumstances. Substantial changes in the thickness of the support structure can produce sink marks on the outer skin, however, which impair the outer skin appearance.

DE 102 49 418 A1 discloses a roof module in which an outer skin is bent over in the area of its edge and is connected with a support frame, which on its part is adhesively bonded with a flange of the vehicle body by means of an adhesive track. The support frame can comprise an undercut, which is used to attach the outer skin to the support frame.

The object of the present invention is to create a roof module for a vehicle, in order to prevent problematic sink marks on the outer skin. Furthermore, it is intended to create an appropriate installation method.

The invention teaches that this problem is solved through a roof module according to claim 1 and an installation method according to claim 11. At the same time, it is advantageous that because the support structure between the adhesive surface and the outer skin is provided with an undercut, any required significant changes in the thickness of the support structure can be shifted, if necessary, to a certain extent into areas in which sink marks resulting from such significant changes in thickness are less problematic, e.g. in edge areas of the outer skin, which are completely invisible when the roof module has been installed.

According to a preferred embodiment of the invention, the outer skin is developed curved in the area of the undercut and/or the adhesive surface. This additionally contributes in preventing and/or reducing problematic sink marks on the outer skin, since sink marks occur less in the curved areas of the outer skin.

Further preferred embodiments of the invention result from the sub-claims.

The invention is explained in detail hereinafter, using the attached drawing, which shows a schematic cross-sectional view of an example of a roof module as taught by the invention in the edge area after the installation on the vehicle.

The roof module 10 shown in the FIGURE comprises an outer skin 12, on the inside of which a support structure 14 containing plastic material is integrally formed. The outer skin 12 can be developed as a plastic film or aluminum or steel sheet and is preferably preformed, before the support structure 14 is integrally formed. The integral forming of the support structure 14 onto the outer skin 12 can be done in a mold, in which the outer skin 12 is back-pressed, back-injected or back-lined with the plastic material. The plastic material preferably involves polyurethane, which can be introduced into the mold by means of a long-fiber-injection process (LFI process). The plastic material can have a honeycomb structure, for example from paper, which is reinforced with a plastic material. The reinforcing can be developed as a polyurethane impregnated fiberglass mat, where the polyurethane is applied by means of a LFI process.

The support structure 14 in its edge area has a flange 16 which constitutes an adhesive surface 18, by means of which the support structure 14—and thus the roof module 10—can be adhesively bonded by means of an adhesive track 20 with a flange 22 which is developed from the edge of an opening in the vehicle body in the roof area. The body flange 22 is normally developed from the roof rails of the vehicle body, so that the roof module 10 replaces the customary sheet metal roof of the vehicle. Preferably, functional units, such as a roofliner, control panels, lighting equipment, sun visors, etc. are already preinstalled on the roof module 10, in order to improve the vehicle assembly efficiency. During the installation on the vehicle, the roof module 10 is placed onto the body flange from above or onto the previously applied adhesive track 20.

The adhesive flange 16 of the support structure 14 is provided with an undercut 24 between the adhesive surface 18 and the outer skin 12, which is developed in the direction across the roof and which is positioned on the side of the adhesive flange 16 and/or the adhesive surface 18 facing the center of the roof. Providing the undercut 24 makes it possible to shift the area, in which the thickness of the support structure 14 significantly varies, far enough toward the edge of the outer skin 12, so that the area of the outer skin 12, behind which is the area of the significant change in thickness of the support structure 14 can be shifted into an area which is not visible after the installation on the vehicle.

The outer skin 12 is preferably developed curved in the area of the undercut 24 and/or the adhesive surface 18, whereby the curvature is preferably convex. By providing a curvature in the area of the significant change in thickness of the support structure 14 on the edge of the undercut 24, the risk of sink marks and/or the extent of the formation of sink marks on the outer skin 12, can be reduced.

Furthermore, in areas in which a particularly high risk for sink marks exists, “design grooves” can be provided, as pointed out schematically in the FIGURE under reference 26. In this instance, the groove 26 is developed by a groove that is generated during the pre-forming of the outer skin 12. In the example shown in the FIGURE, groove 26 is provided in an area in which the thickness of the support structure 14 is reducing (for example from 10 mm to 6 mm). By providing the groove 26, the problematic sink marks which could otherwise occur and be seen on the surface of the outer skin 12, which can be caused by the change in thickness of the support structure 14 in this area, can be prevented and/or concealed.

### LIST OF REFERENCE NUMBERS

10 Roof module
12 Outer skin
14 Support structure
16 Adhesive flange
18 Adhesive surface
20 Adhesive track
22 Body flange
24 Undercut
26 Design groove

1. A roof module for a vehicle with an outer skin, on the inside of which a support structure containing plastic material is integrally formed, said structure being provided on the inside with an adhesive surface which is designed for resting on the edge of an opening in the bodywork in order to be adhesively bonded to the vehicle bodywork, characterized in that the support structure is provided with an undercut between the adhesive surface and the outer skin.

2. The roof module of claim 1, characterized in that the outer skin is developed curved in the area of the undercut and/or the adhesive surface.

3. The roof module of claim 2, characterized in that the curvature of the outer skin in the area of the undercut and/or the adhesive surface is convex.

4. The roof module of claim 1, characterized in that the undercut is developed in the direction across the roof.

5. The roof module of claim 4, characterized in that the undercut is developed at least on the side of the adhesive surface facing the center of the roof.

6. The roof module of claim 1, characterized in that the roof module is formed so that the area of the outer skin, behind which the edge of the undercut lies, is located in an area that is not visible from the outside after the assembly of the vehicle.

7. The roof module of claim 1, characterized in that the outer skin is designed as plastic sheeting or from aluminum or steel sheet.

8. The roof module of claim 1, characterized in that the support structure is designed as a plastic reinforced honeycomb structure.

9. The roof module of claim 8, characterized in that the honeycomb structure involves a paper honeycomb structure with a polyurethane impregnated fiberglass mat.

10. A vehicle which is provided with a roof module of claim 1.

11. A method for installation of a roof module in an opening in the bodywork of a vehicle, whereby in order to develop the roof module a support structure comprising an integrally formed plastic material on the inside of an outer skin on the inside of which an adhesive surface is provided, whereby this support structure is provided with an undercut between the adhesive surface and the outer skin, and where the roof module with its adhesive surface is placed onto the edge of the opening in the bodywork and is adhesively bonded to it by means of an adhesive track.

12. The method of claim 11, characterized in that the outer skin is backed with a plastic material in a mold by means of back-pressing, back-injection or back-lining.

13. The method of claim 11, characterized in that the plastic material is introduced into the mold by means of a long fiber injection process.

14. The method of claim 11, characterized in that the plastic material is introduced into the mold as a plastic reinforced honeycomb structure.

15. The method of claim 14, characterized in that the honeycomb structure involves a paper honeycomb structure with a polyurethane impregnated fiberglass mat.

16. The method of claim 15, characterized in that the polyurethane is applied by means of a long fiber injection process.
